(19) United States
(12) Patent Application Publication
(10) Pub. No.: US 2001/0048974 A1
(43) Pub. Date: Dec. 6, 2001

(54) Methods to create a three- demensional art work by molten polymer

(76) Inventor: Feng Cai, Lake in the Hills, IL (US)

Correspondence Address: FENG CAI, 1403 Royal Oak Lane, Lake in the Hills, IL, 60156, US

(21) Appl. No.: 09/838,040

(22) Filed: Apr. 20, 2001

Related U.S. Application Data
(60) Provisional application No. 60/202,844, filed on May 8, 2000.

(51) Int. Cl. B05D 5/06; B05D 1/36

(52) U.S. Cl. 427/258; 427/407.1

(57) ABSTRACT

The methods to create three-dimensional artworks (such as painting, sculpture, calligraphy) comprise heating and melting the polymeric compounds, applying molten polymeric compounds to various substrates (paper, wood, ceramic, metal, marble, plastics, glass, fabric, rubber, stone). Once applied, the molten polymer can be manipulated at artist's discrete while it is still fluid and soft. The heating applicator and heating tools are used to melt and manipulate the polymeric compounds before or after polymeric compounds solidify. The resulting products have a physical three-dimensional sculptured structure.

### CROSS-REFERENCE TO RELATED APPLICATIONS

Provisional utility patent application with same title of invention was filed on May 8, 2000. The application number is No. 60/202,844.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Synthetic polymer have been widely used in almost every area of our life, including the artistic applications, such as acrylic painting, acrylic sculptures, decorating articles by various molding methods, etc. Acrylic medium used for painting is a water-soluble base polymer. It can be applied directly to substrate by brush. However acrylic painting only create two-dimensional artwork. Acrylic resin used for sculpturing is a thermoset polymer. The complex casting process and molding equipment are used for creating the three-dimensional artwork. Many efforts used other materials have been made to create three-dimensional artwork to reflect our real world scene. Various media and methods have been described by prior arts. U.S. Pat. No. 4,578,131 to Hawkins described a method to creating a three-dimensional sculptured painting by using sand and glue compounds. The method of Hawkins invention includes applying a base coating, scoring, applying second coating, drying, painting. U.S. Pat. No. 5,931,999 of Aisner described a liquid medium for creating three-dimensional art. The liquid medium comprises baking soda, cornstarch, water, gesso, and chalk. The method of Aisner's invention includes applying medium to substrates, drying, coloring, etching, carving, or sanding. U.S. Pat. No. 4,584,042, Wandroik describes an artistic method for creating an art form in the steps of permanently affixing a first substrate material to a second substrate material wherein the second substrate is rigid relative to the first substrate. An artistic method and kit for creating an art form having a textured surface and which appears to be three-dimensional. The transitional material used in the patent is a paraffin material.

Even though there is a diversity of techniques and methods described three-dimensional artwork in the literature, no method has described to use thermoplastic polymer and processing technique to create three-dimensional artworks on various substrates. The present invention describes a novel method applying molten thermoplastic polymers to various substrates to create three-dimensional artworks. The resulting products made by this invention have a physical three-dimensional sculptured structure and more realistic surface textured background.

### BRIEF SUMMARY OF THE INVENTION

The present invention provides the methods to create three-dimensional artworks (such as painting, sculpture, calligraphy) by applying molten polymeric compounds to various substrates (paper, wood, ceramic, metal, marble, plastics, glass, fabric, rubber, stone). The resulting products made by the present invention have a physical three-dimensional sculptured structure and more realistic surface textured background. The processes to create the artworks of the present invention are also much simpler than other three-dimensional art work process described in prior arts. The skills to master the technique of the present invention are very similar to that required by traditional artistic training, such as painting, calligraphy. Therefore, the technique can be easily learnt by fine artists, art students and art lovers.

It is therefore an object of this invention to provide new methods to create three-dimensional artwork.

It is therefore another object of this invention to use the various molten polymer compounds for creating three-dimensional artworks on various substrates.

It is also an object of this invention to use the melting equipment that melt polymer and apply the molten polymer on the substrates in order to create three-dimensional artwork.

It is an object of this invention to use the heated tool to manipulating the shape of the polymers that are applied to the substrates to create desired three-dimensional artwork.

### BRIEF DESCRIPTION OF THE DRAWINGS

FIG. 1 illustrates the process of creating a three dimensional artwork with the heated applicator.

FIG. 2 is a perspective view of the structure of the heated applicator used in this invention.

FIG. 3 illustrates the process of creating a three dimensional artwork with the melting equipment and the heating tool.

### DETAILED DESCRIPTION OF THE INVENTION

The methods to create a three-dimensional artwork by molten polymer material in this invention are described in the following.

Procedures

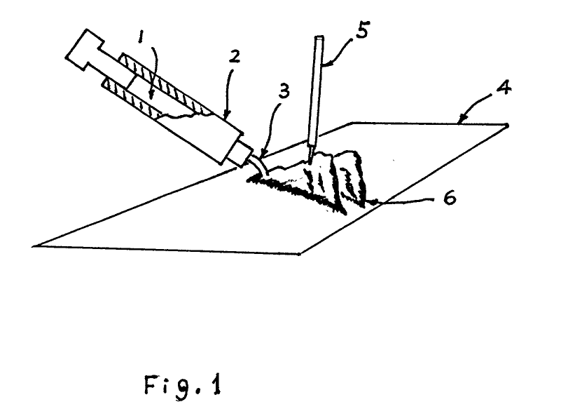

FIG. 1 illustrates the process of creating a three-dimensional artwork with the heated applicator. The process may comprise the following major steps:

1. Load polymer compound 1 into a heated applicator 2.

2. After polymer compound 1 is heated above its flow temperature inside of the heating house of the applicator, the molten polymer is forced out through the applicator's head opening 8 by an advancing system of the applicator. The dispensed molten polymer 3 can be directly applied in the desired area on the substrate 4 at artist's discretion.

3. Before the molten polymer solidified, the molten polymer on the substrate can be manipulated into the artist's desired three-dimensional shape by the heated applicator. If necessary, the heated tool 5 can be used to further modify the artwork.

4. After polymer solidified on the substrate 4, if necessary, the solidified polymer 6 on the substrate can be further sculptured by using a heated tool 5 at artist's discretion. Additional molten polymer 3 can also be applied on top of the solidified polymer 6 in order to achieve desired three-dimensional shape at artist's discretion.

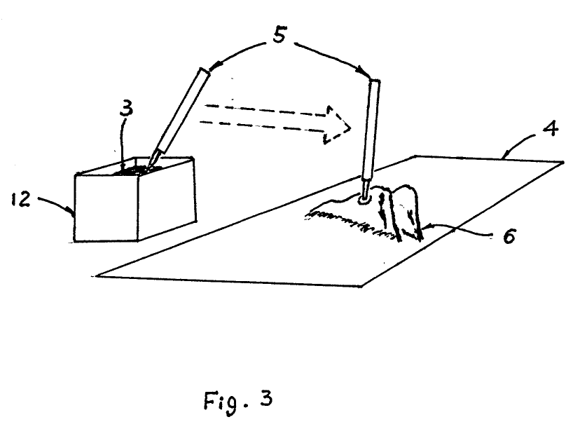

FIG. 3 illustrates the process of creating a three dimensional artwork with the melting equipment and the heated tools. The process may comprise the following major steps:

1. Load one or more polymers compounds 1 into the melting equipment 12.

2. After the polymer compounds melted the molten polymer compounds 3 can be mixed together by the heated tool 5 to the degree at artist's discretion. The molten polymers can also be mixed with pigment or dye by the heated tool at artist's discretion.

3. Use the heated tool 5 to transfer and to apply the molten polymer compounds in the desired area on the substrate 4 at artist's discretion.

4. If necessary, use the heated tool 5 to transfer and to apply the molten polymer compounds on top of the solidified polymer 6 in order to achieve desired three-dimensional shape at artist's discretion.

In practice, The two processes described above can be simultaneously used to create the same artwork.

Materials

Polymer compounds 1 used in this method can be made by a compounding process. The base polymer resins used in present invention can include any kinds of thermoplastic polymers, such as, polyethylene, EVA, polypropylene, polyvinyl chloride, polyamide, polycarbonate, polyester, polyurethane, polystyrene, and their copolymers, etc. Depends on the artistic applications, the base polymer resins may need to mix with other additives, such as, pigments (organic or inorganic), dyes, fillers, processing aid agents, adhesion promoters, biocide agents, etc.

### EXAMPLE 1

| | |
|---|---|
| Example 1 | |
| Polyethylene | 70% by weight |
| EVA | 5% by weight |
| Adhesion promoter | 23% by weight |
| Cadmium red | 1.8% by weight |
| Antioxidant | 0.2% by weight |
| Example 2 | |
| Flexible Polyvinyl chloride | 91% by weight |
| Aluminum powder | 8% by weight |
| Fungicide | 1% by weight |

The additives can be mixed in molten polymer resins on various compounding equipment such as extruders, open mill mixers, hot pots with agitator, internal mixers. The physical forms of the polymer compounds 1 can be melt, powder, pellet, sheet, stick, and rod or other forms.

The substrates 6 used in this invention include paper, wood, ceramic, metal, marble, plastics, glass, fabric, rubber, and stone.

Equipment

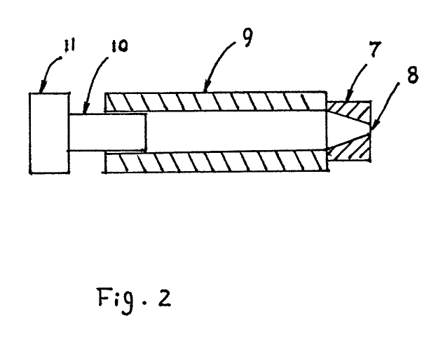

FIG. 2 is a perspective view of the structure of the heated applicator used in this invention. The applicators 2 used in this invention consist of the heating house 9, the pumping system and the applying head 7. The heating house 9 is used for containing the polymer compound 1 and provides the heat to melt the polymer compositions 1. The pumping system is used for forcing molten polymer flowing out through the opening 8 of the applying head 7. The pumping system include the pumping elements 10, for example, extruding screws, pumping gears, pistons and the material grippers, and the power system 11. The power system of pumping system 11 can be mechanical, electrical, pneumatic power. The applying head 7 is used for applying molten polymer 3 on the substrate at artist's discretion, for examples, nozzles, dies, and tubes.

The heated tools 5 used in this invention can be heated by electricity microwave, and directly by flame. The melting equipment 12 used in this invention includes melting pots, roller mixers, screw mixers, gear pump mixers.

I claim:

1. A method of creating the three-dimensional artworks (such as calligraphy, paintings, sculptures ) by using one or more heated tools and one or more heated applicators containing one or more thermoplastic polymer compounds, comprises the steps of:
a) Load said one or more thermoplastic polymers into said heated applicator.
b) After said thermoplastic polymer composition melted, molten polymers are forced out through an applying head of said heated applicator.
c) Apply said molten polymers that come out off said applying head on a substrate to form a solidified polymer layer at artist's discretion and more layers of said molten polymer can be applied on the top of said solidified polymer layer at artist's discretion.
d) Said heated tools can be used to create details of said polymer layer at artist's discretion.

2. The method of claim 1 wherein said polymer compounds are any thermoplastic polymeric resins which may contain or may not contain pigments, dyes, fillers, antioxidants, UV screen agents, adhesion promoters and biocides.

3. The method of claim 1 wherein said polymer compounds can have transparent, translucent, metallic or solid colors.

4. The method of claim 1 wherein said heated applicators are composed of an applying head (such as nozzle, die, flexible tube), a heating house, a pumping system that force molten polymer flowing out through the opening of said applying head.

5. The heated applicator of claim 4 wherein said pumping system may include the pumping elements (such as mixing or extruding screws, pumping gears, pistons or the material gripper) and the power system that is operated with mechanical, electrical, pneumatic power.

6. The method of claim 1 wherein said heated tools can be heated by electricity, by microwave, by ultrasonic or directly by flame.

7. The method of claim 1 wherein said substrates include paper, wood, ceramic, metal, marble, plastics, glass, fabric, rubber, and stone.

8. A method of creating the three dimensional artworks (such as calligraphy, painting, sculpture ) by using one or more said heated tools and by using one or more melting equipment that contains said thermoplastic polymer compounds comprises the steps of:
a) Load one or more said thermoplastic polymer compounds into said melting equipment.
b) After said thermoplastic polymer compounds melt, mix the molten polymers with other ingredients (such as pigments, dyes, fillers etc.) to the degree at artist's discretion.
c) Use said one or more heated tools to transfer and to apply the said mixed polymer melt in the desired area of said substrate to form a solid polymer layer at artist's discretion.
d) If necessary, use said heated tools to transfer and to apply the molten polymer compounds on top of the solidified polymer in order to achieve desired three-dimensional shape at artist's discretion.

9. The method of claim 8 wherein said melting equipment includes melting pot, roll mixer, screw mixer, gear pump mixer.

10. The method of claim 8 wherein said polymer compounds are any thermoplastic polymer resins which contain or may not contain pigments, dyes, fillers, antioxidants, UV screen agents, adhesion promoters and biocides.
